(19) United States
(12) Patent Application Publication
(10) Pub. No.: US 2022/0312544 A1
(43) Pub. Date: Sep. 29, 2022

(54) METHOD AND NETWORK NODE FOR CONFIGURING A TERMINAL BASED ON CAPABILITIES

(71) Applicant: Sony Group Corporation, Tokyo (JP)

(72) Inventors: Rickard LJUNG, Helsingborg (SE); Peter C. KARLSSON, Lund (SE)

(21) Appl. No.: 17/615,505

(22) PCT Filed: May 18, 2020
(86) PCT No.: PCT/EP2020/063791

§ 371 Date: Nov. 30, 2021

(30) Foreign Application Priority Data
Jun. 13, 2019 (SE) 1950705-2

(51) Int. Cl. H04W 76/28; H04W 52/02; H04W 8/22

(52) U.S. Cl. CPC H04W 76/28; H04W 52/0216; H04W 8/22

(57) ABSTRACT

A method for use in a network node (BS1) of a wireless network (100), for configuring communication protocol related parameters of a user equipment, UE (UE1, UE2), connectable to the wireless network, the method comprising: obtaining (502) a request indicator (V1) associated with the UE; determining (504), based on the request indicator, a subrange (611) of a predefined parameter range (610) for a time-related parameter (ParA); configuring (506) a parameter value (ValA1) of the time-related parameter for the UE based on the determined subrange.

### TECHNICAL FIELD

This disclosure relates to methods and devices for configuring communication protocol related parameters of a terminal connectable to a wireless network. More specifically, solutions are provided for determining a range for a time-related parameter, set by the network for use by the terminal.

### BACKGROUND

In wireless communication systems, such as various generations provided through the 3rd Generation Partnership Project (3GPP), various generations of specifications have been provided for setting up common rules for setting up and operating both a wireless radio interface between a wireless terminal and a base station, and various levels of operation of the wireless network. In 3GPP documentation, a wireless terminal, or wireless communication device, is commonly referred to as a User Equipment (UE). The term UE will be used going forward in this disclosure, but it may be noted that the proposed solution may apply to other systems than 3GPP systems. A base station defines a cell and is operative to serve a surrounding area with radio access for UEs, by providing radio access to UEs within a cell. A base station is also referred to herein as an access node, and various terms are used in 3GPP for different types of systems or specification. An access network, or Radio Access Network (RAN), typically includes a plurality of network nodes operating as access nodes. In the so-called 3G specifications, also referred to as the Universal Mobile Telecommunications System (UMTS), the term NodeB is used to denote an access node, whereas in the so-called 4G specifications, also referred to as Long-Term Evolution (LTE), the term eNodeB (eNB) is used. A further developed set of specifications for radio communication are referred to as the 5G type radio communication system (5GS), including the New Radio (NR) technology, wherein the term gNB is used to denote an access node.

The access network may be connected to a Core Network (CN) which inter alia provides access to other communication networks. The core network may comprise a number of different network nodes, having different functionalities, defined in accordance with a certain 3GPP release or in accordance with another set of wireless communication standards. Such network nodes may include a node for handling mobility of UEs, such as an Access & Mobility management Function (AMF), a Session Management Function (SMF), a User Plane Function UPF, and one or more gateways.

UEs can have many different capabilities, such as radio capabilities, e.g., associated with modem properties or supported functionality in the UE, data rate capabilities, maximum MIMO layer capabilities, maximum bandwidth support etc. In order to make various entities of the wireless network aware of the capabilities supported by a certain UE, the UE indicates its capabilities to the wireless network. This is typically accomplished when the UE registers with the wireless communication network, and thereby transmits an indication of its capabilities and feature group indicators (FGI-bits) to the network. The network will then be aware of what type of UE has connected to the network and may take this into account for configuring the communication protocol for the upcoming communication with the UE. Further, the type of service or connection used in the communication with the network may imply a UE capability. Such service may for example be whether or not the UE has a IMS registration, or is utilizing a certain network functionality, such as for example a low latency communication mode, a sidelink communication or a broadcast communication mode. Hence, the term UE capabilities may here refer to such types of functionality information provided from the UE, that can be used by the network to determine the functionalities, use cases and limitations within the UE. The capabilities can be indicated in different formats, e.g., in terms of parameters or indicators listed in one or more information elements of one or more messages. With the increasing amount of UEs operating in the wireless networks, further development has been made to implement so-called UE capabilities IDs for various sets of UE capabilities. A UE capability ID may e.g. be manufacturer-specific, determined by the UE manufacturer, or network-specific for a certain PLMN (Public land mobile network) or a part thereof, determined e.g. by the operator of the network. Further information and definition of capabilities is specified in 3GPP specification 38.306, whereas the RRC signaling between the access network (RAN) and the UE is defined in 3GPP specification 38.331. Definitions associated with UE capability ID signaling within the Core Network can be found in 3GPP specification 23.502.

The network will typically take the UE capabilities, e.g. the UE Category, into account when configuring the data communication in order not to setup a link with any parameter exceeding the UE capability. But besides that, the network typically does not adapt the protocol very much based on the UE capabilities. Examples of parameters that may be configured based on UE capabilities include various timer values, handover thresholds, cell selection thresholds, coverage extension levels (repetition factors), frequency related parameters (bandwidths, frequencies etc.), measurement configurations for radio resource management etc. This list only provides examples to illustrate that the network can allow or configure a huge number of parameters and functions in a network which the UE has no decision control of, besides signaling its potential support.

Historically, leaving any adaptation of such type of parameters open to network implementations has not been a significant problem in 3G and 4G systems. The types of services for UEs running in commercial 3GPP networks have been at least to some extent similar, since devices mainly have been smartphones running voice and data services (web surfing, email, social media etc.). However, the last years several new enablers and features for services have been or are being specified in the later phases of 4G and especially in the 5G standard. Examples are Internet of Things IoT services (NB-IoT and MTC), Ultra Reliable Low Latency Communication (URLLC). Even further so-called verticals are approaching the 3GPP organization with particular requirements, including e.g. industry IoT, gaming, video production, medical applications etc. It is becoming more obvious that there is a huge difference in how well such services, and in some cases also specific UEs, will be able to perform in the network depending on how the network will configure its protocol. For example, the energy consumption of a UE may be strongly dependent on the network configuration.

Accordingly, there is a need for techniques that allow for configuring UEs such that they may operate appropriately in the network according to intended use.

### SUMMARY

A general object is to provide improved solutions for configuration of a UE for setting time-related parameters. Specifically, solutions are related to applying suitable settings within a range of allowed parameter values. A method is therefore proposed for use in a network node BS1 of a wireless network 100, for configuring communication protocol related parameters of a user equipment UE, connectable to the wireless network. A network node configured to operate according to such a method is further proposed. The method comprises:

obtaining a request indicator associated with the UE;

determining, based on the request indicator, a subrange of a predefined parameter range for a time-related parameter;

configuring a parameter value of the time-related parameter for the UE based on the determined subrange.

This way, a parameter value to be set within a general predefined parameter range which may be allowable or specified under a communication protocol, e.g. as specified under the 3GPP and/or defined by UE capabilities of the UE, may be conveniently set within a subrange that is suitable to the intended use or type of UE.

The solution is determined by the terms of the independent claims, and various embodiments are laid out in the dependent claims.

### BRIEF DESCRIPTION OF THE DRAWINGS

Various embodiments will be described with reference to the drawings, in which

FIG. 1 schematically illustrates a network of a wireless communication system including networks nodes according to various embodiments;

FIG. 2 schematically illustrates elements included in a UE configured in accordance with various embodiments;

FIG. 3 schematically illustrates elements included in a network node of a wireless network configured in accordance with various embodiments;

FIG. 4 schematically illustrate energy consumption over time for a UE in transition between different states;

FIG. 5 shows a flow chart including several method steps carried out a network node according to various embodiments;

FIG. 6 schematically illustrates mapping of UE capabilities for different UEs in a wireless network according to various embodiments;

FIG. 7 shows a signal diagram for managing capability IDs, including transmission between various entities of a wireless network according to various embodiments; and

FIG. 8 schematically illustrates selection of a parameter setting for a UE based on UE capabilities and a requested subrange according to various embodiments.

### DETAILED DESCRIPTION OF EMBODIMENTS

The invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “connected” to another element, it can be directly connected to the other element or intervening elements may be present. In contrast, when an element is referred to as being “directly connected” to another element, there are no intervening elements present. Like numbers refer to like elements throughout. It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Well-known functions or constructions may not be described in detail for brevity and/or clarity. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Embodiments of the invention are described herein with reference to schematic illustrations of idealized embodiments of the invention. As such, variations from the shapes and relative sizes of the illustrations as a result, for example, of manufacturing techniques and/or tolerances, are to be expected. Thus, embodiments of the invention should not be construed as limited to the particular shapes and relative sizes of regions illustrated herein but are to include deviations in shapes and/or relative sizes that result, for example, from different operational constraints and/or from manufacturing constraints. Thus, the elements illustrated in the figures are schematic in nature and their shapes are not intended to illustrate the actual shape of a region of a device and are not intended to limit the scope of the invention.

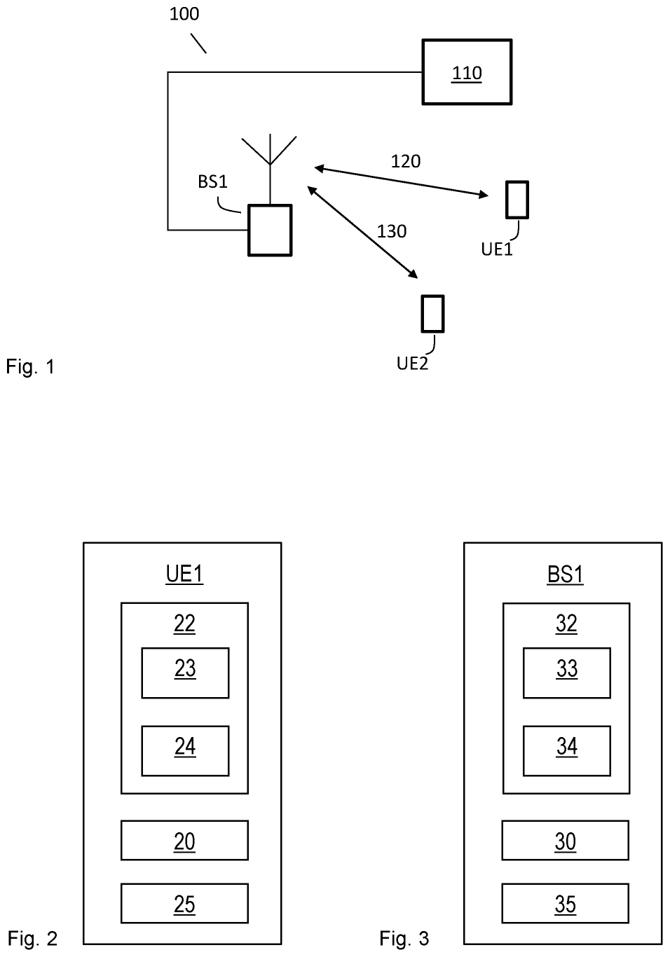

FIG. 1 schematically illustrates a wireless network 100 of a wireless communication system. The wireless network comprises a core network 110 which provides access to other communication networks, such as the Internet, and an access network for communication with UEs. The access network may include a plurality of access nodes, of which a first access node BS1 is shown, configured to serve various cells. The access network may e.g. be a Radio Access Network (RAN). In the drawing, two UEs UE1 and UE2 are shown. Each UE is a wireless device configured to communicate wirelessly with access nodes BS1 of the wireless network 100 on a channel 120, 130, such as by radio. UEs may be stationary or mobile.

The CN 110 may include various core network nodes, defined in accordance with a certain 3GPP release or in accordance with another set of wireless communication standards. Such CN entities may include nodes for handling mobility of UEs, such as an Access & Mobility management Function (AMF). Other CN entities may include a Session Management Function (SMF), a User Plane Function (UPF) and one or more gateways such as a Serving Gateway and a PDN Gateway.

Each access node BS1 may in various embodiments be referred to as a base station, serving one or more cells each. The access network may comprise a number of access network groups, supported and served by one or more network nodes for UE mobility management. Each access network group may comprise a plurality of access nodes. In various embodiments, an access network group is defined as a portion of the entire access network, which portion is served by one AMF or one AMF set, which AMF set may include several AMFs. Each access node BS1 has a configured interface to the core network 110 for Control plane and User plane, referred to as N2 and N3 interfaces in 5G. Corresponding interfaces S1-C and S1-U are provided in LTE. Access nodes may further be inter-connected by means of a logical inter-node interface. In 5G, this interface, or set of interfaces, is referred to as Xn interface, and has a similar purpose as the X2 interface defined for LTE.

For the purpose of managing UE capabilities in the network 100, a global or database may be included (not shown), and one or more local databases connected to serve e.g. one AMF. Such databases may be configured to store UE capabilities, also referred to as capability information herein, for the network 100. The database 116 may further store capability IDs associated with various combinations, parts, or subsets of such capability information. In various embodiments, the global database stores data for whole PLMN.

FIG. 2 schematically illustrates a UE1 of FIG. 1 but could equally well illustrate the included functional elements of UE2. The UE1 may be configured for communication with the access network of the wireless network 100, and comprise a transceiver 20, such as a radio receiver and transmitter for communicating with an access node of the network 100 through at least an air interface. For this purpose, the transceiver is connected to a communication interface 25, such as an antenna. The UE1 further comprises logic 22. The logic 22 may comprise for example a controller or microprocessor 23. The logic may also comprise or be connected to a data storage device 24 configured to include a computer readable storage medium. The data storage device 24 may include a memory and may be, for example, one or more of a buffer, a flash memory, a hard drive, a removable media, a volatile memory, a non-volatile memory, a random access memory (RAM), or other suitable device. In a typical arrangement, the data storage device 24 includes a non-volatile memory for long term data storage and a volatile memory that functions as system memory for the controller 23. The data storage device 24 may exchange data with the controller 23, e.g. a processor, of the logic 22 over a data bus. The data storage device 24 is considered as a non-transitory computer readable medium. One or more processors of the controller 23 of logic 22 may execute instructions stored in the data storage device 24 or a separate memory in order to carry out operation of the UE1, as outlined herein. The UE1 may further comprise a data memory for storing UE capability information and associated data, such as a capability ID. The data memory may be or form part of the data storage device 24 or be a separate entity. It may be noted that the UE1 clearly may include other features and functions than those identified, such as e.g. one or more antennas, a user interface, a power source and so on, but these components are not shown in FIG. 2 for clarity reasons.

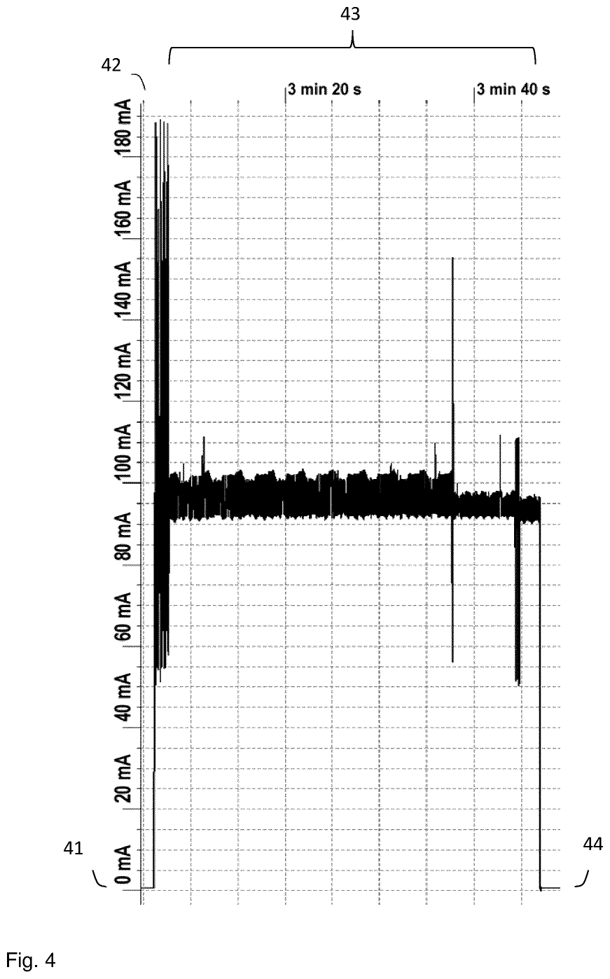

FIG. 3 schematically illustrates an access node BS1. The access node BS1 comprises access node logic 32. The access node logic 32 may for example comprise a controller or microprocessor 33. The logic 32 may also comprise or be connected to a data storage device 34 configured to include a computer readable storage medium. The data storage device 34 may include a memory and may be, for example, one or more of a buffer, a flash memory, a hard drive, a removable media, a volatile memory, a non-volatile memory, a random access memory (RAM), or other suitable device. In a typical arrangement, the data storage device 34 includes a non-volatile memory for long term data storage and a volatile memory that functions as system memory for the controller 33. The data storage device 34 may exchange data with a processor 33 of the logic 32 over a data bus. The data storage device 34 is considered as a non-transitory computer readable medium. One or more processors 33 of the logic 32 may execute instructions stored in the data storage device or a separate memory in order to carry out operation of the access node BS1 as outlined herein. The access node BS1 may comprise more components, for example a power supply, but these components are not shown in FIG. 4 for clarity reasons. The access node BS1 may further comprise one or more transceivers 30 for communication with other entities. For example, the transceiver 30 may comprise a radio transceiver connected to an antenna arrangement 35, for communication over an air interface with UEs, such as UE1 and UE2. Moreover, the transceiver 30 may define one or more interfaces to the core network 100. The access node BS1 may further comprise a data memory for storing UE capability information and associated data, preferably for a plurality of UEs. The data memory may form part of the data storage device 34 or be a separate entity.

FIG. 4 schematically shows an example of the energy consumption over time for a UE modem comprising at least the transceiver 20 and controlled by the logic 22, for a procedure where the UE switches between states. The UE makes use of a communication procedure for simple upload or download of data. In this example, the UE is an NB-IoT device, but the illustrated energy consumption may apply to other procedures too. Such an NB-IoT device is configured for small data rates and uses a subset of the LTE standard, wherein the bandwidth is typically limited to a single narrow-band of 200 kHz. NB-IoT may advantageously be used for devices that only need to communicate data with the network 100 between long intervals of non-communication, i.e. idle periods, and provides low cost and long battery life. Moreover, for such devices, the communication carried out may oftentimes be only exchange of a limited set of data, such as a single upload of data to the network 100 in the uplink UL, and/or download of data from the network in the downlink DL.

In the drawing, the UE is switching, at a point 41, from idle to active mode, such as RRC_CONNECTED, transmitting a small amount of data, waiting for command to go back to idle mode, and finally switching to Idle mode again at a point 44. In the drawing, the higher energy values indicated at 42 represent the UL transmission of data. As may further be gathered from FIG. 1, the short transmission period 42 is followed by a longer period 43 during which the UE is waiting for the network 100 to release the UE back to idle. In fact, the vast majority of energy may be spent during the waiting period 43, in which the UE is forced to maintain the active mode although no data transmission or reception is carried out. From an IoT device perspective this not a suitable/expected network behavior, but still it is allowed according to standard. The network 100 may e.g. be configured to operate with an inactivity timer, controlling the length of the period 43, applied for a traffic pattern of typical user-operated UE, such as a smartphone. The inactivity time may thus be configured such that the network 100 does not have to force a state switch for the UE every time a user makes use of the UE, but rather maintain an active, connected, state for some time. The rationale behind this may be that it is normally expected that once a user has begun operating the UE, the user will normally operate it again within some time, such as by starting an application, sending a message etc.

With reference to FIG. 4, the 3GPP specifications may allow a long inactivity timer, since there is no requirement to tailor the parameters according to the UE type, as e.g. indicated by the UE capabilities and/or the UE FGI bits. In short, the above network example does not adapt its behavior for UEs registering as e.g. NB-IoT UEs, and the end result is a sub-optimal network configuration for specific UE categories or UEs operating with scarce and simple data upload and/or download. In various communication protocols, such as 3GPP LTE, there are a few features that are only allowed to be configured for certain UE categories. Such implementations are included in order to put a limit on the required UE hardware complexity. Typical example is that the lower UE categories have limitations in their required bandwidth, e.g. one of the MTC categories has a maximum configured bandwidth of 1.4 MHz, and NB-IoT categories are limited to 200 kHz, the maximum transport block size may be limited to accommodate a maximum capability of data buffer and/or decoder capability within the UE, and not more than one-layer transmission is allowed, i.e. No MIMO. However, there are no constraints in parameters configuring the software configurations e.g. timer values.

For these purposes, solutions are provided herein for including a mapping rule between one, or a combination of, UE capabilities and one or more parameter configuration range limitations.

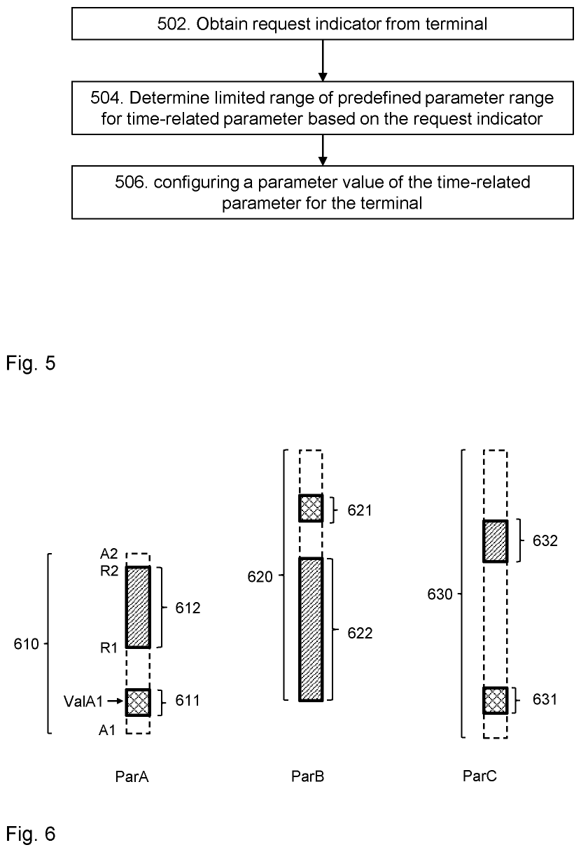

With reference to FIG. 5, and in accordance with a general aspect of this disclosure, a method is proposed for use in a network node BS1 of a wireless network 100, for configuring communication protocol related parameters of a user equipment UE1, connectable to the wireless network. The method comprises:

obtaining 502 a request indicator V1 associated with the UE1;

determining 504, based on the request indicator, a subrange of a predefined parameter range for a time-related parameter ParA;

configuring 506 a parameter value ValA1 of the time-related parameter for the UE based on the determined range, i.e. said subrange.

This way, a parameter value to be set within a general predefined parameter range which may be allowable or specified under a communication protocol, e.g. as specified under the 3GPP, may be conveniently set within a limited range that is suitable to the intended use or type of UE.

With reference to the example of FIG. 4, an improvement of the state of the art may be obtained by means of the proposed solutions, in that the period 43 may be shortened to a suitably selected minimum, such that a state switch back to idle may be carried out conveniently fast, e.g. once any data buffer for UL and/or DL transmission has been emptied.

In practice this could be implemented by specifying that dedicated configuration ranges of the protocol, such as a time-related parameter ParA is for use by the UE for controlling a connection state with respect to the network, e.g. timer values to be used, are limited or bounded based on the UE capability signaling from the UE. In various embodiments, a parameter set describing timing configurations for active and idle mode discontinuous reception (DRX) as well as state switching has UE capability-based limitations. In various embodiments one or more time-related parameters for use by the UE for controlling its behavior in its communication with the network are mandated to be activated or deactivated. One time-related parameter may e.g. be configured is for use by the UE1 for controlling a connection state with respect to the network.

FIG. 6 schematically illustrates setting of time-related parameters ParA, ParB and ParC for two different UEs, UE1 and UE2 of FIG. 1. The time-related parameters may e.g. include an inactivity timer for switching from an active mode or state to an inactive mode or state, such as from RRC_CONNECTED to RRC_IDLE, a cycle or period for extended DRX etc.

Specific examples of the time-related parameters ParA, ParB, ParC may include Active mode DRX parameters, such as

DRX Cycle, defining duration of one ‘ON time’+one ‘OFF time’, calculated by the subframe time and longdrx-CycleStartOffset)

onDurationTimer, defining duration of ‘ON time’ within one DRX cycle

drx-Inactivity timer, specifying how long the UE should remain ‘ON’ after the reception of a PDCCH.

drx-Retransmission timer, specifying the maximum number of consecutive PDCCH subframes the UE should remain active to wait an incoming retransmission after the first available retransmission time.

shortDRX-Cycle, which can be implemented within the ‘OFF’ period of a long DRX Cycle.

drxShortCycleTimer, identifying consecutive number of subframes the UE shall follow the short DRX cycle after the DRX Inactivity Timer has expired.

Other specific examples may include Idle mode DRX/eDRX parameters, such as DRX cycle, eDRX cycle, paging time window for the eDRX functionality etc.

The monitoring of paging has implications on device battery lifetime and the latency of DL data delivery to the UE. A compromise is achieved by configuring the DRX cycle and/or an eDRX cycle. In some implementations the maximum DRX cycle is 256 frames (2.56 s) in both idle and connected mode, and the maximum eDRX cycle is 256 hyperframes (about 44 min) in idle mode and 1024 frames (10.24 s) in connected mode. After each eDRX cycle, a paging time window occurs, configurable up to 2048 subframes (20.48 s) during which DL reachability is achieved through the configured DRX cycle.

In some embodiments, the time-related parameters ParA, ParB, ParC may include other UE related network management timers, such as UE side timers for EPS Mobile Management, e.g. various Tracking Area update timers.

It should be clear from the above that the example of three different time-related parameters ParA, ParB, ParC is only one implementation selected to illustrate the embodiment, and that the different UEs, such as UE1 and UE2, may have different preferences for different time-related parameters. The solution proposed herein applies to at least one time-related parameter.

It should be noted that the drawing of FIG. 6 serves to illustrate that different settings may be configured by the network 100 for different UEs, and that this may entail configuration of one or more time-related parameters. In different embodiments, though, only a single time-related parameter may be set in accordance with the proposed method. Furthermore, it will be readily understood by the skilled reader that network configuration of a UE may involve setting further parameters which are not time-related parameters.

When a UE registers to the network 100, the network 100 may transmit an enquiry message to obtain UE capability information from the UE. The UE may transmit a message in the uplink, containing its UE capabilities, herein also referred to as capability information. This process may also include the UE transmitting various feature group indicators in the UL.

In some embodiments, the UE may be configured to transmit a capability ID in the UL, rather than or in combination with, the full capability information. The capability ID may be a pre-stored manufacturer specific manufacturer specific ID, relevant for a specific type or model of UE, and be associated with the capabilities of that UE. In such an embodiment, the capability ID is relevant for any access network, and the associated UE capabilities may be retrieved from a database held by the manufacturer, or from a network database in which a mapping between the manufacturer specific capability ID and associated UE capabilities have been mirrored. In other embodiments, the capability ID may be PLMN specific, and relevant for the access network of network 100 as a whole, or for an access network group of that access network. In such an embodiment, the capability ID is assigned by the network 100, and may be an identity that reflects the full UE capabilities, or a filtered set, relevant for the network 100.

Besides reporting capability information or capability ID at registration, it may be noted that a UE may subsequently report updated or changed capability information or ID also in connected state, or in RRC messaging.

Referring again to FIG. 6, the vertical columns with dashed contours provide each one predefined parameter range 610, 620, 630 for a time-related parameter ParA, ParB and ParC, respectively. Vertically, a time axis may be associated with each predefined parameter range, though not necessarily the same scale or offset for the different parameters ParA, ParB, ParC. Specifically, for the example embodiment, a first time-related parameter ParA may have a predefined parameter range 610 extending from a first parameter value A1 to a second parameter value A2. The predefined parameter range 610 may be determined by a 3GPP specification, and the end values A1, A2, of which at least one may be open, may be given as specific values or as parameter values calculated based on other values or functions, provided by 3GPP specification. In various embodiments, the predefined parameter range 610 is the range which is supported by the respective UE. Corresponding end values may apply to predefined parameter range 620 for ParB and predefined parameter range 630 for ParC but for the sake of simplicity these have been left out of the drawings.

For full compliance with the communication protocol operated by the network 100, the network may configure the UE to use any parameter value of the time-related parameters ParA, ParB, ParC within the associated predefined parameter range 610. 620, 630, respectively. The UE is also required to report its UE capability, which may cover the entire parameter range for the respective time-related parameter. However, not all parameter values may be suitable for a certain UE, such as UE1 and UE2, or for a certain use case of such UE, even though it is capable of operating under such parameter settings.

For this purpose, the network 100 may, by means of a network node such as the access node BS1 or a core network node connected to the access node, carry out a mapping to determine a limited subrange of the predefined parameter range for a time-related parameter. The subrange is in various embodiments a portion of the full range of the associated UE capability for the respective time-related parameter.

With reference to the example of FIG. 6, UE1 has an associated subrange 611 for ParA, a subrange 621 for ParB and a subrange 631 for ParC. On the other hand, UE2 has an associated subrange 612 for ParA, a subrange 622 for ParB and a subrange 632 for ParC. The drawing shown an embodiment where UE1 and UE2 are associated with different subranges, but in other embodiments one or more of the parameters ParA, ParB, ParC may have associated subranges that are the same or are overlapping for UE1 and UE2. For the sake of simplicity, reference will mostly be made to configuration of UE1 going forward.

Identification of the respective limited parameter range of a subrange may be obtained by the network node based on a request indicator V1. In some embodiments, the request indicator may form part of the UE capabilities or feature group indicator. In other embodiments, the indicator V1 may be conveyed separately, e.g. in an RRC message. The request indicator may thus be obtained in the network node from the UE. In other embodiments, the request indicator V1 may be obtained from an application server, which may be connected to the network 100 and remotely operated to transmit the request indicator V1 to the network node, e.g. by a user of the UE.

In some embodiments, the request indicator V1 is a UE type indicator. V1 may thus indicate, or be realized by means, of e.g. a UE category.

In some embodiments, a UE1 may be adapted to operate for a certain use case, such as being assigned to a certain vertical. This intended use case, or vertical, may e.g. be industry IoT, gaming, video production, medical applications etc.

In some embodiments, the UE1 may be configured in accordance with different use cases, such as those described, or in different modes of operation. As an example, the UE1 may be configured to operate as a standard smartphone, for communication, gaming, web searching etc., which as such may be defined as different modes of operation. Moreover, a request indicator V1 may define a mode of operation of the UE as one of the aforementioned modes, or as a completely different mode of operation. Specifically, the UE1 may in various embodiments be operated as a standard smartphone, and in another mode of operation be operated as an NB-IoT device. The request indicator V1 may thus indicate this mode of operation to the network 100 and obtain configuration from the network 100 suitable for the intended mode of operation. As exemplified herein, a request indicator V1 for an NB-IoT mode of operation may correlate to a requested shorter inactivity timer value.

The network node may further be adapted to configure a parameter value for the UE based on the determined subrange. The configured parameter value may be a specific value, or a range for the UE to selectively set a value within, of the time-related parameter. Unless the network optionally overrides the request indicator V1 and assumes another value within the predetermined range, the parameter value for the UE is set within the determined subrange.

Referring back to FIG. 4, the period 43 may correspond to range 610 of FIG. 6, ranging from value A1 to value A2. Period 43 may thus be determined by an inactivity timer defined by ParA. In accordance with the UE capabilities of UE1, ParA may be configured by the network node to a value ValA within the predetermined specified range 610, which may e.g. be in the range from A1=0 seconds to A2=2 minutes, e.g. ValA=1 minute.

However, the UE1 may be adapted to operate as a device for scarce and simple data communication, such as a sensor meter or a positioning device, configured to upload small amount of data with long intermediate periods of inactivity of several minutes, hours or days. In this context, the UE may be an NB-IoT device, or may be temporarily be set to operate solely as an NB-IoT device. The UE1 may for these or other reasons not benefit from a long inactivity time, since a completed data upload will mark the end of the required active state, after which the UE1 may immediately return to idle unless there is some data to be downloaded from a buffer in the network 100. The request indicator V1 therefore identifies, to the network 100, a subrange 611 from R1 to R2, which subrange is smaller than the predetermined range 610. Specifically, a subrange towards the lower part of the scale for the inactivity timer ParA is identified by the request indicator V1, e.g. between R1=10 ms to R2=1 s.

Where the network node accepts to allow the determined subrange 611 as identified by the request indicator V1, the network node configured the UE1 with a parameter value ValA1 for the UE based on, and preferably within, the determined subrange 611.

The indicator V1 may provide an identification of the respective limited parameter range for the subrange requested or desired to be used as default, or for from a certain point in time, or for a certain time period. The latter embodiments provide the possibility to set e.g. a substantially standard smartphone, normally used for e.g. Internet surfing, gaming and communication, to a low power mode for e.g. surveillance or for monitoring a sensor value, while obtaining a more energy-efficient operation to save battery time.

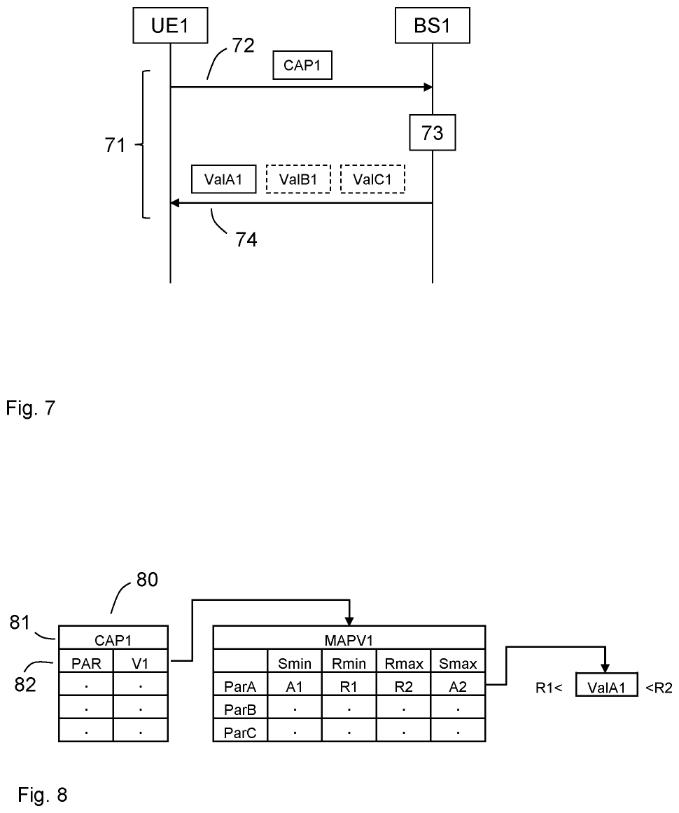

FIG. 7 schematically illustrates a signaling diagram, including communication between the network 100, represented by the access node BS1, and the first.

The process 71 indicates registration of the UE1 to the network 100 and shows provision of at least UE capabilities CAP1 associated with the UE1 to the network 100. As noted, conveying of capability information to the network 100, specifically the access node BS1, may alternatively be provided at a later stage, post registration, and may also involve the use of a capability ID. In the example embodiment of FIG. 7, the UE1 transmits 72 a UE capability report over the radio interface to the access node BS1 of the serving cell, when UE1 registers to the network 100. The transmission of CAP1 may be preceded by the network 100 requesting the UE1 to send the relevant capabilities in a “UE Capability Enquiry” message (not shown). The UE responds with transmission 71 of a “UE Capability Information” message CAP1.

The network node, such as the access node BS1 or a core network node, will in a processing step 73 obtain a request indicator V1 associated with the UE1. As noted, the request indicator V1 may be received from the UE1, or e.g. from an application server. Based on the request indicator V1, a subrange 611 of a predefined parameter range 610 for a time-related parameter ParA is determined. The determined subrange 611 may be given directly and explicitly by the request indicator V1, or by mapping in a database. A parameter value ValA1 of the time-related parameter may thereby be determined. In this process, the network node may take other factor into consideration, such as overall traffic information, and detected previous behavior of the UE1 or of a registered user of UE1, where applicable.

In a step 74, the time-related parameter ParA is configured to ValA1, within the determined subrange 611, by conveying a message identifying ValA1 to UE1.

Step 74 further indicates the optional configuration of further parameters, such as ParB to ValB1 and ParC to ValC1. It may be noted that one or more of these parameters may be set within an associated determined subrange 621, 631, or optionally within the associated predetermined range 620, 630 but outside the determined subrange 621, 631.

FIG. 8 schematically illustrates selection of a parameter setting ValA1 for the UE1 based on UE capabilities and a requested subrange for configuration of UE1, in accordance with various embodiments outlined herein.

To the left of FIG. 8, the UE capabilities 81, or capability information, for UE1 are indicated. The capability information may be stored in memory 24 or other memory storage of UE1. Transmission of the capability information may e.g. be accomplished by the UE1 transmitting a bitmap 80 to indicate its UE capabilities to the network 100. The receiving access network may store the capability information and may convey that data for storage. Transmission may be accomplished upon initial registration of the UE1 with the network 100 or at a later point of time, as described. For example, the UE1 could transmit the bitmap while maintaining a connection to the network 100, e.g., for indicating an update of its capabilities. The bitmap may include a plurality of bits from which subsets of one or more bits indicate whether or not, and optionally also in which way, a certain capability is supported by the UE. For example, a single bit of “1” could indicate that the capability is supported. A subset of multiple bits could indicate one of multiple options of supporting a certain capability, a level of support, e.g. distinguishing between no, basic, and full support, and/or one or more parameters related to the capability, e.g. a maximum supported bitrate when using the capability. The mapping of capabilities to bit positions in the bitmap may be preconfigured in the UE and the access node BS1. Such pre-configuration may be based on a telecommunication standard and may be based on factory settings or on operator defined settings. Accordingly, the support of a certain capability may be indicated in a binary manner (e.g., by a single bit indicating either “supported” or “unsupported”), but also be indicated by multiple bits, e.g., to indicate a level of support, a selected option, or one or more parameters related to the capability.

In addition to the UE capabilities 81 as such, a request indicator V1 is indicated, which may prescribe a desired or advantageous setting of a value or subrange for one or more capability parameters PAR 82. While the UE capabilities 81 and the request indicator V1 are noted in the same table in FIG. 8, it shall be noted that they may be transferred to the network 100 separately, as outlined.

In the central part of FIG. 8, it is indicated how the network node, such as the access node BS1, maps an obtained request indicator V1 to a subrange R1 to R2 of a predetermined specified range A1 to A2, corresponding to the full UE capability of UE1. This may involve consulting a lookup table MAPV1. In the drawing, a lookup table is indicated specifically for request indicator V1, but needless to say a common lookup table may be employed for all request parameters. Alternatively, separate lookup tables may be employed for each parameter type ParA, ParB, ParC etc.

The right part of FIG. 8 illustrates configuration of the UE1 to a parameter value ValA1 within the subrange between R1 and R2, hence meeting the request expressed by request parameter V1. This way, the UE1 may be set to operate with a setting that is more advantageous than at least certain other settings provided within the full UE capabilities of that UE1.

In accordance with a general aspect, and encompassing the embodiments disclosed herein, solutions are provided herein related to a network node BS1 of a wireless network 100, for configuring parameters of a UE1, connectable to the wireless network, configured to carry out any of the method steps as outlined herein. The network node comprises:
a transceiver 30 for communicating with the UE1;
logic 32 configured to
   obtain 502 a request indicator V1 associated with the UE1;
   determine 504, based on the request indicator, a subrange 611 of a predefined parameter range 610 for a time-related parameter ParA;
   configure 506 a parameter value ValA1 of the time-related parameter for the UE1.

Operation in accordance with the embodiments outlined herein may be exemplified and understood through the following scenarios:

As a first scenario one may consider a network 100 which may have been configured with a default parameter set ParA, ParB, ParC describing various time-related parameters, such as network timers to be used in a cell for active and/or idle mode, DRX, as well as timers for state switching. This could for example mean that the network node BS1, upon a registered UE1 requesting extended DRX activation, the cell transmits a value to be used for extended DRX interval, being set to a first given value or is being inactivated according to a default configuration. Alternatively, or additionally, when the UE1 registers the access node BS1 transmits RRC configuration information to the UE1 which includes e.g. an idle and/or a connected mode DRX configurations (e.g. long DRX, short DRX, on-duration time etc.) set to values according to a first set of given values. These values could be selected within a general allowed range 610, 620, 630 provided in 3GPP specifications for a general rule of usage. This first scenario can be considered to the legacy behavior.

As an evolution of this scenario, a second scenario is provided by the solutions presented herein. When a UE1 registers to the network 100 and transmits UE capability information with a request V1 for a restrained configuration, the network 100 may

a) Determine that the UE1 which indicated capability or combination of capabilities define a “parameter constrained UE”, e.g. by assessment of the request indicator.

b) Identify which timer values ParA, ParB, ParC are “limited” in their allowed range 610, 620, 630, based on the signaled UE capabilities and which subranges 611, 621, 631 are then desired for these identified timers, e.g. based on a lookup from a table MAPV1 of constrained parameters per UE capability combination.

In various embodiments, the network 100 is required to follow the request indicator V1 and configure a value ValA1 within the associated range, as long as the subrange 611 is a portion within the allowed predetermined range 610. In various embodiments the network 100 is required to activate and/or inactivate one or more time-related parameters based on the signaled UE capabilities. Such examples may include but are not limited to cases were a network is mandated to configure an extended DRX value or a power save mode operation for a UE based on the signaled UE capabilities. In an alternative embodiment, the parameter value limitation could be defined as a recommendation, meaning that in such case there is not a strict limitation but instead a recommended subrange for one or more parameter values, for the network 100 to configure for the UE1.

c) Determine whether default parameters set in the cell for the parameters ParA, ParB, ParC as used in the first scenario are within the narrower range 611, 621, 631 identified in b).

d) If the default parameters are not within the allowed range based on the determination in c), the cell selects a different value within the allowed constrained subrange 611, 621, 631. As an option, this step is optional based on that the subrange was defined as a recommendation in b) or that the cell may determine that there is a need to override the parameter value limitations. There may be one or more scenarios determined in the 3GPP standard specifications describing in which circumstances the network 100 is allowed to override the subrange value limitations identified by the request indicator V1.

Various aspects and embodiments encompassing the solutions described herein are outlined in the following claims.

1. A method for use in a network node of a wireless network, for configuring communication protocol related parameters of a user equipment (UE) connectable to the wireless network, the method comprising:
obtaining a request indicator associated with the UE;
determining, based on the request indicator, a subrange of a predefined parameter range for a time-related parameter;
configuring a parameter value of the time-related parameter for the UE based on the determined subrange.

2. The method of claim 1, wherein said request indicator is a UE type indicator.

3. The method of claim 1, wherein said request indicator is a use case indicator associated with the UE.

4. The method of claim 3, wherein said request indicator defines a mode of operation of the UE.

5. The method of claim 1, comprising
obtaining, from the UE, information identifying communication capabilities of the UE in the wireless network, which information includes said request indicator.

6. The method of claim 1, comprising
wherein said subrange is determined using a rule mapping associated with the request indicator.

7. The method of claim 1, wherein configuring the time-related parameter includes
setting the parameter value within the subrange.

8. The method of claim 1, wherein configuring the time-related parameter includes
setting the parameter value within the predefined parameter range and outside the subrange.

9. The method of claim 1, wherein configuring the time-related parameter includes
transmitting the parameter value to the UE.

10. The method of claim 1, comprising
determining, for each of a plurality of time-related parameters and based on the request indicator, a respective subrange of a respective predefined parameter range;
configuring, for each time-related parameter, a parameter value for the UE.

11. The method of claim 1, wherein said time-related parameter is a timer for use by the UE.

12. The method of claim 1, wherein the time-related parameter is for use by the UE for controlling a connection state with respect to the network.

13. The method of claim 1, wherein the parameter value defines one or more of a DRX period timer, an extended DRX period, a timer controlling time in-between switching between two RRC states, an on-duration timer, a retransmission timer, for use by the UE.

14. The method of claim 1, wherein said network node is access node of the wireless network.

15. A network node of a wireless network, for configuring parameters of a user equipment (UE) connectable to the wireless network, comprising:
a transceiver for communicating with the UE;
logic configured to
obtain a request indicator associated with the UE;
determine, based on the request indicator, a subrange of a predefined parameter range for a time-related parameter;
configure a parameter value of the time-related parameter for the UE.

16. (canceled)

17. The network node of claim 15, wherein the network node is an access node of the wireless network.
